(19) United States
(12) Patent Application Publication
(10) Pub. No.: US 2026/0124599 A1
(43) Pub. Date: May 7, 2026

(54) METAL-ORGANIC FRAMEWORK WITH 3-DIMENSIONAL POROUS NETWORK STRUCTURE, ADSORBENT INCLUDING THE SAME, AND METHOD OF PREPARING THE METAL-ORGANIC FRAMEWORK WITH 3-DIMENSIONAL POROUS NETWORK STRUCTURE

(71) Applicants: EWHA UNIVERSITY - INDUSTRY COLLABORATION FOUNDATION, Seoul (KR); UIF (University Industry Foundation), Yonsei University, Seoul (KR)

(72) Inventors: Hoi Ri MOON, Seongnam-si (KR); Junsu HA, Seoul (KR); Youn-Sang BAE, Seoul (KR); Kwang Hyun OH, Seoul (KR); Jihyun PARK, Seoul (KR); Seungjin LEE, Seoul (KR); Kyu-Min RYOUM, Seoul (KR)

(21) Appl. No.: 19/383,333

(22) Filed: Nov. 7, 2025

(30) Foreign Application Priority Data
Nov. 7, 2024 (KR) 10-2024-0157466

(51) Int. Cl. B01J 20/22; B01D 53/02; B01J 20/30; C07F 3/06

(52) U.S. Cl. CPC B01J 20/226; B01D 53/02; B01J 20/3085; C07F 3/06; B01D 2253/204; B01D 2257/11; B01D 2257/7022

(57) ABSTRACT

Provided are a metal-organic framework with a three-dimensional porous network structure, an adsorbent including the same, and a method of preparing the metal-organic framework with a three-dimensional porous network structure. The metal-organic framework with a three-dimensional porous network structure includes: a Zn₄O cluster; and two or more types of carboxyl group-based aromatic ligands having different degrees of bulkiness, wherein one of the carboxyl group-based aromatic ligands includes a carboxyl group-based aromatic ligand including a C4-C8 alkoxy group, an opening is defined by the carboxyl group-based aromatic ligand, and the opening has a multivariated size due to vibration of a pendant chain of the C4-C8 alkoxy group.

### TECHNICAL FIELD

The present disclosure relates to a metal-organic framework with a three-dimensional porous network structure, an adsorbent including the same, and a method of preparing the metal-organic framework with a three-dimensional porous network structure.

### BACKGROUND ART

Extensive studies have been conducted on metal-organic frameworks (MOFs) for various gas-separation applications because MOFs may be designed as structures with high specific surface area, porosity, and flexibility.

However, in some cases, it is difficult to selectively separate a desired gas with high purity due to a small difference between kinetic diameters of mixed gas molecules, or significant cost and energy are required depending on separation conditions of mixed gases. For example, in order to selectively separate a desired gas with high purity, additional processes such as adsorption and desorption may be required or processes need to be carried out in an environment under cryogenic conditions.

To solve these problems, hydrogen-bonded organic frameworks (HOFs), which rely on characteristics of weak hydrogen bonds, have been used, or MOFs with reduced pore sizes under humid conditions have been utilized. However, these approaches have not achieved the levels required to selectively and efficiently separate gases with high purity.

Meanwhile, among characteristics of metal-organic frameworks (MOFs), arrangement of openings, i.e., pores, plays an important role in determining gas separation and adsorption performance. However, it is difficult to obtain precise arrangement and adjustment of MOFs under dry conditions.

Therefore, there is a need to develop a metal-organic framework (MOF) having a novel structure, which, by adjusting the sizes of fine pores and arranging the pores without changing the shape of the MOF, exhibits improved selectivity, separation stability, separation efficiency, and capacity for a gas to be separated under dry conditions, an adsorbent including the MOF, and a method of preparing the MOF.

### DISCLOSURE OF INVENTION

### Technical Problem

Provided is a metal-organic framework with a 3-dimensional porous network structure having improved selectivity, separation stability, separation efficiency, and capacity for a gas to be separated under dry conditions.

Provided is an adsorbent including the metal-organic framework.

Provided is a method of preparing the metal-organic framework with a 3-dimensional porous network structure, capable of efficiently, selectively separating a gas to be separated under dry conditions.

### Solution to Problem

According to an aspect of the present disclosure, a metal-organic framework with a 3-dimensional porous network structure includes:
a Zn₄O cluster; and
two or more types of carboxyl group-based aromatic ligands having different bulkiness,
wherein one of the carboxyl group-based aromatic ligands includes a carboxyl group-based aromatic ligand including a C4-C8 alkoxy group,
an opening is defined by the carboxyl group-based aromatic ligands, and
the opening has a multivariated size due to vibration of a pendant chain of the C4-C8 alkoxy group.

The carboxyl group-based aromatic ligand may include an unsubstituted carboxyl group-based aromatic ligand and a carboxyl group-based aromatic ligand including a C4-C8 alkoxy group.

The carboxyl group-based aromatic ligand may include 1,4-benzenedicarboxylate and 2,5-bis(alkoxy)benzenecarboxylate represented by Formula 2 below:

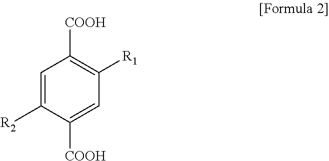

in Formula 2,
R₁, and R₂ are each independently an unsubstituted C4-C8 alkoxy group.

A major axis diameter of the opening is 1.5 Å to 4.2 Å.

The pendant chain of the C4-C8 alkoxy group of the carboxyl group-based aromatic ligand including a C4-C8 alkoxy group may be densely distributed in the opening.

An opening smaller than the opening may be additionally defined in the opening by the pendant chain of the C4-C8 alkoxy group.

The pendant chain of the C4-C8 alkoxy group may narrow a distance between a target molecule and the Zn₄O cluster in the smaller opening to enhance interactions therebetween.

The metal-organic framework has a core-shell, wherein a ligand located in the shell has a bulkier structure than a ligand located in the core.

The opening of the shell may be a space for capturing the target molecule, and the opening of the core may be a space for storing the target molecule.

The target molecule may be ethane (C₂H₆) or xenon (Xe).

The metal-organic framework may have a structure in which a proportion of the bulkier ligand gradually increases from the center to the surface among the two or more carboxyl group-based aromatic ligands.

A proportion of the bulkier ligand present on the surface is 80 vt % or more based on a total volume of the metal-organic framework.

A total volume of the openings may be 0.50 cm³/g or more based on a total volume of the metal-organic framework.

The metal-organic framework may selectively separate ethylene (C₂H₄) from a mixed gas of ethylene (C₂H₄) and ethane (C₂H₆).

The metal-organic framework may selectively separate krypton (Kr) gas from a mixed gas of xenon (Xe) and krypton (Kr) gas.

According to another aspect of the present disclosure, an adsorbent includes the above-described metal-organic framework.

According to another aspect of the present disclosure, a method of preparing a metal-organic framework with a 3-dimensional porous network structure includes:
preparing a solution including a first carboxyl group-based aromatic ligand; and
adding a Zn₄O cluster precursor solution, and a first metal-organic framework including a Zn₄O cluster and a second carboxyl group-based aromatic ligand to the solution including the first carboxyl group-based aromatic ligand, followed by heat-setting at a temperature of 70° C. to 95° C. and then standing to obtain a second metal-organic framework crystal having a core-shell structure,
wherein the first carboxyl group-based aromatic ligand is a carboxyl group-based aromatic ligand including a C4-C8 alkoxy group,
the second carboxyl group-based aromatic ligand is less bulky than the first carboxyl group-based aromatic ligand,
an opening is defined by the first carboxyl group-based aromatic ligand and the second carboxyl group-based aromatic ligand, and
in the second metal-organic framework crystal,
the first carboxyl group-based aromatic ligand is located in the shell, and
the second carboxyl group-based aromatic ligand is located in the core.

According to another aspect of the present disclosure, a method of preparing the metal-organic framework with a 3-dimensional porous network structure includes:
preparing a solution including a third carboxyl group-based aromatic ligand; and
adding a Zn₄O cluster precursor solution and a fourth carboxyl group-based aromatic ligand precursor solution to the solution including the third carboxyl group-based aromatic ligand, followed by heat-setting at a temperature of 90° C. to 110° C. and then standing to obtain a metal-organic framework crystal having a mixed-linker structure,
wherein the third carboxyl group-based aromatic ligand is a carboxyl group-based aromatic ligand including a C4-C8 alkoxy group,
the fourth carboxyl group-based aromatic ligand is less bulky than the third carboxyl group-based aromatic ligand,
an opening is defined by the third carboxyl group-based aromatic ligand and the fourth carboxyl group-based aromatic ligand, and
the metal-organic framework crystal
has a structure in which a proportion of the third carboxyl group-based aromatic ligand gradually increases from the center to the surface, depending on a crystallization rate.

### Advantageous Effects of Invention

A metal-organic framework (MOF) with a 3-dimensional porous network structure and an adsorbent according to an embodiment includes a carboxyl group-based aromatic ligand including a C4-C8 alkoxy group. An opening is defined by the carboxyl group-based aromatic ligand, and the opening has a multivariated size due to vibration of a pendant chain of the C4-C8 alkoxy group. The metal-organic framework (MOF) may have improved selectivity, separation stability, separation efficiency, and capacity for a gas to be separated under dry conditions.

A metal-organic framework with a 3-dimensional porous network structure according to another embodiment may easily selectively separate a gas to be separated under dry conditions.

### BRIEF DESCRIPTION OF DRAWINGS

FIG. 1 schematically illustrates manufacturing methods and structures of a CSMOF-C5 metal-organic framework (core/shell, (a)) according to Example 1 and a MLMOF-C5 metal-organic framework (mixed, (b)) according to Example 2.

FIG. 2 schematically illustrates manufacturing methods and structures of a CSMOF-C8 metal-organic framework (core/shell, (a)) according to Example 3 and a MLMOF-C8 metal-organic framework (mixed, (b)) according to Example 4.

FIG. 3 shows optical microscope (OM) images and Raman spectroscopy results of distribution of ligands in the crystals of a CSMOF-C5 metal-organic framework (core/shell, (a)) according to Example 1 and a MLMOF-C5 metal-organic framework (mixed, (b)) according to Example 2.

FIG. 4 shows optical microscope (OM) images and Raman spectroscopy results of crystals of a CSMOF-C8 metal-organic framework (core/shell, (a)) according to Example 3 and a MLMOF-C8 metal-organic framework (mixed, (b)) according to Example 4.

FIG. 5 shows ethane (C₂H₆) (a) and ethylene (C₂H₄) (b) gas adsorption isotherms of the IRMOF-1, IRMOF-5, CSMOF-C5, and MLMOF-C5 metal-organic frameworks prepared in Comparative Examples 1 and 2 and Examples 1 and 2 obtained at 298 K for 10 cycles.

FIG. 6 shows xenon (Xe) (a) and krypton (Kr) (b) gas adsorption isotherms of the IRMOF-1, IRMOF-8, CSMOF-C8, and MLMOF-C8 metal-organic frameworks prepared in Comparative Examples 1 and 3 and Examples 3 and 4 obtained at 298 K for 5 cycles.

FIG. 7 shows the ideal adsorbed solution theory (LAST) gas selectivity of the IRMOF-1, IRMOF-5, CSMOF-C5, and MLMOF-C5 metal-organic frameworks prepared in Comparative Examples 1 and 2 and Examples 1 and 2 for ethane (C₂H₆) and ethylene (C₂H₄) according to changes in pressure.

FIG. 8 shows the ideal adsorbed solution theory (IAST) gas selectivity of the IRMOF-1, IRMOF-8, CSMOF-C8, and MLMOF-C8 metal-organic frameworks prepared in Comparative Examples 1 and 3 and Examples 3 and 4 for xenon (Xe) and krypton (Kr) according to changes in pressure.

FIG. 9 is a schematic diagram of a customized fixed-bed setup for dynamic breakthrough experiments.

FIG. 10 shows evaluation results for ethylene (C₂H₄) separation performance from a mixed gas of ethane (C₂H₆) and ethylene (C₂H₄) (50/50, v/v) by a CSMOF-C5 metal-organic framework (b) and an MLMOF-C5 metal-organic framework (a) prepared in Examples 1 and 2.

FIG. 11 shows evaluation results for krypton (Kr) separation performance from a mixed gas of xenon (Xe) and krypton (Kr) (50/50, v/v) by a CSMOF-C8 metal-organic framework (b) and an MLMOF-C8 metal-organic framework (a) prepared in Examples 3 and 4.

### MODE FOR THE INVENTION

Hereinafter, a metal-organic framework with a 3-dimensional porous network structure, an adsorbent including the same, and a method of preparing the metal-organic framework with a 3-dimensional porous network structure according to an embodiment of the present disclosure will be described in detail with reference to the accompanying drawings. Accordingly, it should be apparent to those skilled in the art that the following description of various embodiments of the present disclosure is provided for illustration purpose only and not for the purpose of limiting the present disclosure as defined by the appended claims and their equivalents.

The terms used herein are merely used to describe particular embodiments and are not intended to limit the present inventive concept. An expression used in the singular encompasses the expression of the plural, unless it has a clearly different meaning in the context.

Expressions such as “at least one of” or “one or more”, when preceding a list of elements, modify the entire list of elements and do not modify the individual elements of the list.

Throughout the specification, the term “include” in relation to an element does not preclude other elements but may further include another element, unless otherwise stated.

Throughout the specification, terms “first”, “second”, “third”, “fourth”, “primary”, “secondary”, “tertiary”, “quaternary,” and the like are used to distinguish one component from another, without indicating order, quantity, or importance. The term “or” refers to “and/or”, unless otherwise stated.

As used herein, the terms “an embodiment”, “embodiments”, and the like indicate that elements described with regard to an embodiment are included in at least one embodiment described in this specification and may or may not present in other embodiments. In addition, it may be understood that the described elements are combined in any suitable manner in various embodiments.

Unless otherwise stated, all percentages, parts, ratios, and the like are based on weight. When an amount, concentration, other value, or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed.

Where a range of numerical values is recited herein, unless otherwise stated, the range is intended to include the endpoints thereof, and all integers and fractions within the range. The scope of the disclosure is intended not to be limited by a specific value mentioned when a range is defined.

Unless otherwise stated, the unit “parts by weight” refers to a weight ratio of each component and the unit “parts by mass” refers to a converted solid content of a weight ratio of each component.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations or within ±30%, 20%, 10%, or 5% of the stated value.

Unless otherwise defined, all terms (including technical and scientific terms) used herein have the same meaning as commonly understood by one of ordinary skill in the art to which this disclosure belongs. Also, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments will be described herein with reference to schematic cross-sectional views of ideal embodiments. Therefore, for example, as a result of manufacturing techniques and/or tolerances, the illustrated shapes may vary. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the actual shape of a region of a device and are not intended to limit the scope of claims.

In general, in a mixed gas of ethane (C₂H₆) and ethylene (C₂H₄), a size difference between two molecules is less than 0.4 Å, and thus it is difficult to remove ethane (C₂H₆) and selectively obtain ethylene (C₂H₄) with a high purity. In order to selectively obtain krypton (Kr) from a mixed gas of xenon (Xe) and krypton (Kr) as radioactive components, an energy-intensive cryogenic distillation method, which is inefficient in both cost and energy consumption, has been used.

In the case of the mixed gas of ethane (C₂H₆) and ethylene (C₂H₄), due to a slight difference in kinetic diameter of mixed gas molecules, it is difficult to selectively separate a target gas with high purity. In the case of the mixed gas of xenon (Xe) and krypton (Kr), high cost and energy are required depending on a separation environment.

In order to solve the above-described problems, the present inventors have proposed a metal-organic framework (MOF), an adsorbent, and a method of preparing the metal-organic framework (MOF) below.

### Metal-Organic Framework (MOF) and Adsorbent

A metal-organic framework (MOF) according to an embodiment has a 3-dimensional porous network structure.

The metal-organic framework (MOF) according to an embodiment includes a Zn₄O cluster and two or more types of carboxyl group-based aromatic ligands having different bulkiness. In general, the metal-organic framework (MOF) has a structure in which oxide-centered Zn₄O tetrahedral clusters are connected at vertices thereof by six carboxyl group-based aromatic ligands to constitute a 3-dimensional (3-dimensional) cubic porous network, thereby providing an octahedral secondary building unit (SBU) forming a net.

The metal-organic framework (MOF) according to an embodiment includes a carboxyl group-based aromatic ligand including a C₄-C₈ alkoxy group as one of the carboxyl group-based aromatic ligands. For example, the carboxyl group having a C₄-C₈ alkoxy group may be a straight-chain or branched butyloxy, pentyloxy, hexyloxy, heptyloxy, or octyloxy group. For example, the aromatic ligand may include an aryl ligand or a heteroaryl ligand. For example, the aromatic ligand may be an aryl ligand or a benzyl ligand.

The vertices are connected by the carboxyl group-based aromatic ligands to define pores, i.e., openings.

The carboxyl group-based aromatic ligand including a C₄-C₈ alkoxy group, as a linker, forms an expandable interpenetrating framework, thereby providing a metal-organic framework (MOF) with appropriate porosity. The opening may have a multivariated size due to vibration of a pendant chain of the C₄-C₈ alkoxy group.

The metal-organic framework (MOF) according to an embodiment may improve selectivity and efficiency of separation performance of a desired gas, such as ethylene (C₂H₄) from a mixed gas of ethane (C₂H₆) and ethylene (C₂H₄) and separation performance of krypton (Kr) gas from a mixed gas of xenon (Xe) and krypton (Kr) gas, by including the carboxyl group-based aromatic ligand including a C₄-C₈ alkoxy group.

The carboxyl group-based aromatic ligand according to an example embodiment may include a unsubstituted carboxyl group-based aromatic ligand and a carboxyl group-based aromatic ligand including a C₄-C₈ alkoxy group. The carboxyl group-based aromatic ligand includes two types of ligands having different volumes.

For example, the carboxyl group-based aromatic ligand may include 1,4-benzenedicarboxylate and 2,5-bis(alkoxy)benzenecarboxylate represented by Formula 2 below:

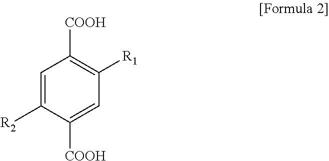

in Formula 2,
R₁ and R₂ are each independently an unsubstituted C4-C8 alkoxy group.

A major axis diameter of the opening according to an example embodiment may be 1.5 Å to 4.2 Å. When a shape of the opening is spherical, the major axis diameter refers to a diameter. When the shape of the opening is elliptical, or the like, the major axis diameter refers to a length of the longer axis.

Because the opening of the metal-organic framework (MOF) according to an embodiment has a multivariated size, a major axis diameter of the opening may be adjusted by controlling a length of the pendant chain of the C4-C8 alkoxy group in accordance with a size of the target molecule to be adsorbed.

The metal-organic framework (MOF) according to an embodiment has weak interactions such as van der Waals interactions between an oxygen atom (O) of the Zn₄O cluster and a hydrogen atom (H) of the target molecule and has pores, i.e., openings, by the carboxyl group-based aromatic ligands.

The pendant chains of the C4-C8 alkoxy group of the carboxyl group-based aromatic ligand including the C4-C8 alkoxy group according to an example embodiment are densely distributed within the opening. Due to the dense distribution of the pendant chains of the C4-C8 alkoxy group in the opening, separation efficiency may be improved by about 58% in comparison with a single-component metal-organic framework (MOF).

An opening smaller than the opening may be additionally defined in the opening by the pendant chain of the C4-C8 alkoxy group according to an example embodiment.

The pendant chain of the C4-C8 alkoxy group according to an example embodiment may narrow a distance between the target molecule and the Zn₄O cluster in the smaller opening to enhance interactions therebetween. Accordingly, the metal-organic framework (MOF) according to an embodiment may have an increased adsorption amount and improved adsorption efficiency of the target molecule.

The metal-organic framework (MOF) according to an embodiment may have a core-shell MOF (CSMOF) structure or a mixed-linker MOF (MLMOF) structure.

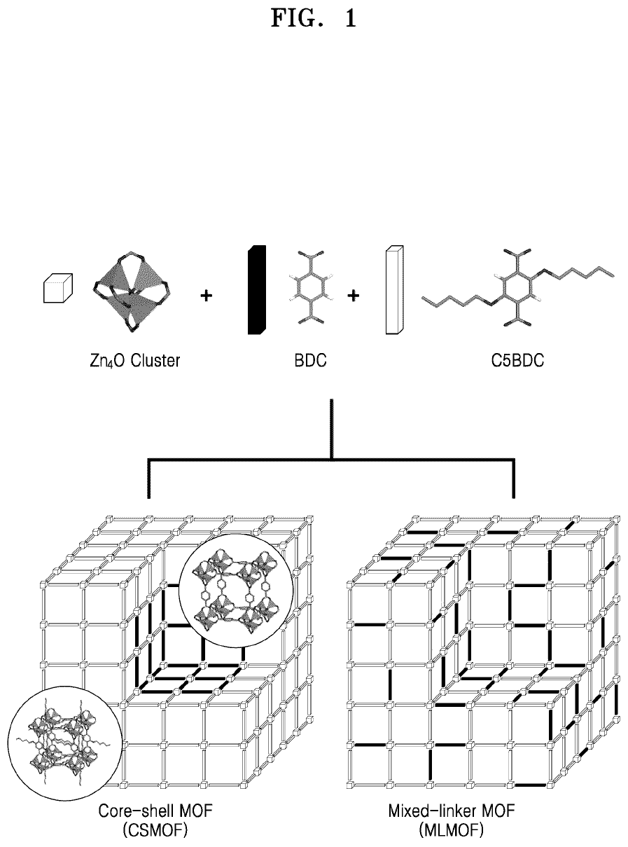

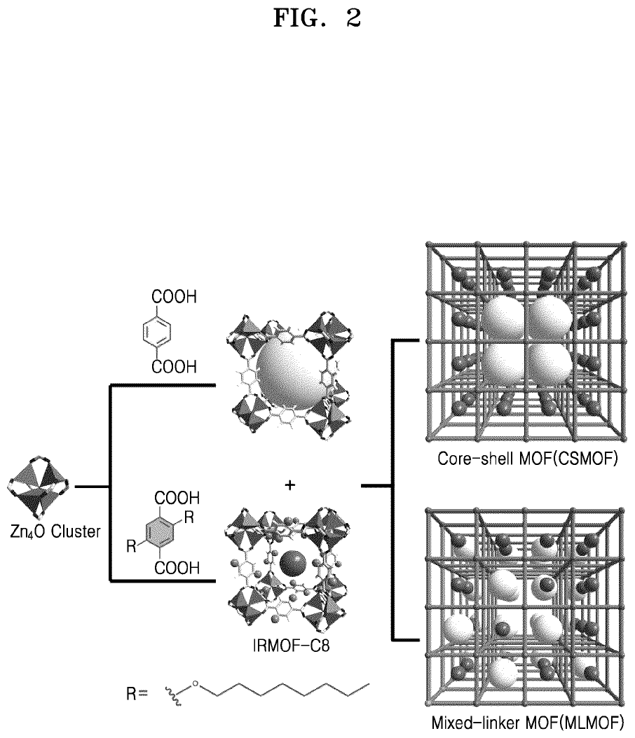

The metal-organic framework (MOF) according to an example embodiment will be described with reference to FIG. 1.

FIG. 1 schematically illustrates manufacturing methods and structures of a CSMOF-C5 metal-organic framework (core/shell, (a)) according to Example 1 and a MLMOF-C5 metal-organic framework (mixed, (b)) according to Example 2.

Referring to (a) of FIG. 1, the CSMOF-C5 metal-organic framework has a core-shell, wherein a ligand located in the shell has a bulkier structure than a ligand located in the core. For example, the ligand located in the shell is 2,5-bis(pentyloxy)benzenecarboxylate (C5BDC), and the ligand located in the core is 1,4-benzenedicarboxylate (BDC). Such a core-shell structure may control gas diffusion sequentially from the shell to the core, and thus selectivity and capacity for gas separation may be precisely adjusted.

The opening of the shell of the metal-organic framework according to an example embodiment may be a space for capturing the target molecule, and the opening of the core may be a space for storing the target molecule.

In the metal-organic framework according to an example embodiment, the target molecule may be ethane (C₂H₆) or xenon (Xe). For example, the opening of the shell of the metal-organic framework according to an example embodiment may be a space for capturing ethane (C₂H₆) or xenon (Xe), and the opening of the core may store ethane (C₂H₆) or xenon (Xe).

The metal-organic framework according to an embodiment may capture ethane (C₂H₆) from a mixed gas of ethane (C₂H₆) and ethylene (C₂H₄) and store ethane (C₂H₆), and then allow the ethylene (C₂H₄) gas to flow out of the metal-organic framework, thereby enabling selective separation.

The metal-organic framework according to an embodiment may capture xenon (Xe) from a mixed gas of xenon (Xe) and krypton (Kr) and store xenon (Xe), and then allow the krypton (Kr) gas to flow out of the metal-organic framework, thereby enabling selective separation of the krypton (Kr) gas.

Referring to (b) of FIG. 1, the MLMOF-C5 metal-organic framework has a mixed-linker (MLMOF) structure. Although the MLMOF-C5 metal-organic framework is prepared by mixing 1,4-benzenedicarboxylate (BDC) and 2,5-bis(pentyloxy)benzenecarboxylate (C5BDC), a structure in which a proportion of the bulkier ligand among the two or more carboxyl group-based aromatic ligands gradually increases from the center to the surface, depending on a crystallization rate. It is considered that this is because the less bulky ligand, BDC is used as a seed and the bulkier ligand, C5BDC, which has a different crystallization rate, is positioned in the surface.

The metal-organic framework having the MLMOF structure may have maximized separation selectivity, separation stability, separation efficiency, and capacity for a gas to be separated, because the bulkier carboxyl group-based aromatic ligand is more densely distributed so that more smaller openings are defined within the opening and the major axis diameter of the opening is more finely adjusted in comparison with the core-shell metal-organic framework in which ligands are clearly distinguished between the core and the shell.

A proportion of the bulkier ligand present in the surface is 80 vt % or more based on a total volume of the metal-organic framework according to an example embodiment.

In the metal-organic framework according to an example embodiment, a total volume of the opening may be 0.50 cm³/g based on the total volume. For example, the total volume of the opening may be 0.51 cm³/g or more, 0.52 cm³/g or more, 0.53 cm³/g or more, 0.54 cm³/g or more, or 0.55 cm³/g or more based on the total volume of metal-organic framework.

An adsorbent according to another embodiment may include the above-described metal-organic framework. In addition, the above-described metal-organic framework may be used for various applications such as catalysts, electrolyte membranes, and drug delivery\.

### Method of Preparing Metal-Organic Framework (MOF)

A method of preparing a metal-organic framework with a 3-dimensional porous network structure according to another embodiment includes: preparing a solution including a first carboxyl group-based aromatic ligand; and adding a Zn₄O cluster precursor solution, and a first metal-organic framework including a Zn₄O cluster and a second carboxyl group-based aromatic ligand to the solution including the first carboxyl group-based aromatic ligand, followed by heat-setting at a temperature of 70° C. to 95° C. and then standing to obtain a second metal-organic framework crystal having a core-shell structure, wherein the first carboxyl group-based aromatic ligand is a carboxyl group-based aromatic ligand including a C4-C8 alkoxy group, the second carboxyl group-based aromatic ligand is less bulky than the first carboxyl group-based aromatic ligand, an openings is defined by the first carboxyl group-based aromatic ligand and the second carboxyl group-based aromatic ligand, and in the second metal-organic framework crystal, the first carboxyl group-based aromatic ligand is located in the shell, and the second carboxyl group-based aromatic ligand is located in the core.

First, the solution including the first carboxyl group-based aromatic ligand is prepared. The first carboxyl group-based aromatic ligand may be a carboxyl group-based aromatic ligand including a C4-C8 alkoxy group.

The solution is prepared by adding the first carboxyl group-based aromatic ligand to an organic solvent such as dimethylformamide (DMF) or diethylformamide (DEF). Examples of the carboxyl group-based aromatic ligand having a C4-C8 alkoxy group are as described above, and thus descriptions thereof will be omitted.

Subsequently, the Zn₄O cluster precursor solution, and the first metal-organic framework including the Zn₄O cluster and the second carboxyl group-based aromatic ligand are added to the solution including the first carboxyl group-based aromatic ligand to prepare a mixture.

Examples of the Zn₄O cluster precursor may be Zn(NO₃)₂, Zn(NO₃)₂·6H₂O, Zn₄O(CH₃CO₂)₆, Zn₄O(C₂₀O₆H₁₂)₃, or Zn₄O(C₂₄H₁₅N₆O₆)₂(H₂O)₂]·6H₂O, but are not limited thereto, and any Zn₄O cluster precursors available in the art may also be used.

The Zn₄O cluster precursor solution, and the first metal-organic framework including the Zn₄O cluster and the second carboxyl group-based aromatic ligand may be added simultaneously or sequentially.

The second carboxyl group-based aromatic ligand may be less bulky than the first carboxyl group-based aromatic ligand. Examples of the second carboxyl group-based aromatic ligand may be an unsubstituted carboxyl group-based aromatic ligand, for example, 1,4-benzenedicarboxylate. Examples of a solvent used in the solution may be dimethylformamide (DMF) or diethylformamide (DEF), but are not limited thereto, and any solvents available in the art may also be used.

The mixture is heat-set in an oven under vacuum at a temperature of 70° C. to 100° C., for example, 80° C. to 90° C., and then allowed to stand for 30 hours to 60 hours, for example, 40 hours to 55 hours, to prepare a mother solution. Then, the mother solution is discarded and a product is washed to obtain the second metal-organic framework crystal having a core-shell structure.

According to the method of preparing the metal-organic framework, the opening is defined by the first carboxyl group-based aromatic ligand and the second carboxyl group-based aromatic ligand, and the opening has a multivariated size due to vibration of a pendant chain of the C4-C8 alkoxy group.

The second metal-organic framework crystal has a 3-dimensional porous network structure in which the first carboxyl group-based aromatic ligand is located in the shell, and the second carboxyl group-based aromatic ligand is located in the core.

According to the method of preparing the metal-organic framework having the core-shell structure, gas diffusion from the shell to the core may be sequentially controlled, and thus selectivity and capacity for gas separation may be precisely controlled.

A method of preparing a metal-organic framework with a 3-dimensional porous network structure according to another embodiment includes: preparing a solution including a third carboxyl group-based aromatic ligand; and adding a Zn₄O cluster precursor solution and a fourth carboxyl group-based aromatic ligand precursor solution to the solution including the third carboxyl group-based aromatic ligand, followed by heat-setting at a temperature of 90° C. to 110° C. and then standing to obtain a metal-organic framework crystal having a mixed-linker structure, wherein the third carboxyl group-based aromatic ligand is a carboxyl group-based aromatic ligand including a C4-C8 alkoxy group, the fourth carboxyl group-based aromatic ligand is less bulky than the third carboxyl group-based aromatic ligand, an opening is defined by the third carboxyl group-based aromatic ligand and the fourth carboxyl group-based aromatic ligand, the metal-organic framework crystal has a structure in which a proportion of the third carboxyl group-based aromatic ligand gradually increases from the center to the surface, depending on a crystallization rate.

First, the solution including the third carboxyl group-based aromatic ligand is prepared. The solution including the third carboxyl group-based aromatic ligand may include a carboxyl group-based aromatic ligand including a C4-C8 alkoxy group and may be prepared in the same manner as that of the solution including the first carboxyl group-based aromatic ligand.

Subsequently, the Zn₄O cluster precursor solution and the fourth carboxyl group-based aromatic ligand precursor solution are added to the solution including the third carboxyl group-based aromatic ligand to prepare a mixture.

The fourth carboxyl group-based aromatic ligand may be less bulky than the third carboxyl group-based aromatic ligand. Examples of the fourth carboxyl group-based aromatic ligand precursor may be an aryl dicarboxylic acid solution or a benzyl dicarboxylic acid solution.

The solution including the third carboxyl group-based aromatic ligand, the Zn₄O cluster precursor solution, and the fourth carboxyl group-based aromatic ligand precursor solution may be added simultaneously or sequentially.

The mixture is heat-set in an oven under vacuum at a temperature of 90° C. to 120° C., for example, 100° C. to 120° C., and then allowed to stand for 30 hours to 60 hours, for example, 40 hours to 55 hours, to prepare a mother solution. Then, the mother solution is discarded and a product is washed to obtain the fourth metal-organic framework crystal having a mixed-linker structure.

According to the method of preparing the metal-organic framework, the opening is defined by the third carboxyl group-based aromatic ligand and the fourth carboxyl group-based aromatic ligand, and the opening has a multivariated size due to vibration of a pendant chain of the C4-C8 alkoxy group.

The fourth metal-organic framework crystal has a 3-dimensional porous network structure in which a proportion of the third carboxyl group-based aromatic ligand gradually increases from the center to the surface, depending on a crystallization rate.

According to the method of preparing the metal-organic framework having the mixed-linker structure, separation selectivity, separation stability, separation efficiency, and capacity for a gas to be separated may be maximized, because the bulkier carboxyl group-based aromatic ligand is more densely distributed so that more smaller openings are defined within the opening and the major axis diameter of the opening is more finely adjusted in comparison with the metal-organic framework having the core-shell structure.

According to the above-described method of preparing the metal-organic framework, ethylene (C₂H₄) gas or krypton (Kr) gas may be efficiently, selectively separated from a mixed gas of ethylene (C₂H₄) and ethane (C₂H₆) or a mixed gas of xenon (Xe) and krypton (Kr), respectively. In addition, the above-described method of preparing the metal-organic framework may improve separation selectivity, separation stability, separation efficiency, and capacity for a gas to be separated.

Hereinafter, the disclosure will be described in more detail with reference to the following examples and comparative examples. However, the following examples are merely presented to exemplify the disclosure, and the scope of the disclosure is not limited thereto.

### EXAMPLES

Unless otherwise stated, all reagents and solvents except for diethylformamide (DEF) were purchased from commercial suppliers and used without further purification. Optical microscope (OM) images were recorded using a Nikon SMZ745T microscope equipped with a TrueChrome Metrics camera. N₂ and CO₂ adsorption isotherms were measured at 77 K and 195 K, respectively, using BELSORP-max (Microtrac BEL Corp., Japan). Prior to the adsorption experiments, samples were degassed under vacuum at 120° C. for 12 hours. The specific surface area was calculated from the linear region of the Brunauer-Emmett-Teller (BET) equation. The micropore volume was calculated using the Horvath-Kawazoe (HK) method and the Grand Canonical Monte Carlo (GCMC) method. Fourier-transform nuclear magnetic resonance (FT-NMR) spectra were collected using a Bruker Avance III 300 spectrometer at the Institute for Basic Science, Ewha Womans University. Raman spectra were collected using a WITec alpha300R equipped with a ×10 objective lens and a 532 nm laser at the Central Research Facility (UCRF) of the Ulsan National Institute of Science and Technology (UNIST).

### Synthesis Example 1: Dimethyl 2,5-Dihydroxyterephthalate

Dimethyl succinylsuccinate (41.4 g, 182 mmol) was added to acetic acid (128 mL) and heated to 80° C. while stirring. After reaching 80° C., N-chlorosuccinimide (25.0 g, 187 mmol) was slowly added thereto and the mixture was stirred at 80° C. for 1 hours. Then, a resulting precipitate was collected by filtration and washed with acetic acid, distilled water, and diethylether. A product was dried under vacuum at 130° C. to obtain dimethyl 2,5-dihydroxyterephthalate as a yellow crystal. ¹H NMR (400 MHZ, CDCl₃) δ/ppm 10.05 (s, 2H), 7.47 (s, 2H), 3.97 (s, 6H).

### Synthesis Example 2: 2,5-Bis(pentoxy)-1,4-benzenedicarboxylic Acid (C5BDC) Ligand

Dimethyl 2,5-dihydroxyterephthalate (4.00 g, 17.9 mmol) and K₂CO₃ (7.32 g, 53.0 mmol) were added to N,N-diethylformamide (120 mL). Under an Ar atmosphere, 1-bromopentane (6.57 mL, 53.0 mmol) was added thereto and the mixture was stirred at 85° C. for 30 hours. After filtration, the organic solvent was removed from the filtrate using a rotary evaporator. Distilled water (200 mL), KOH (10 g, 178 mmol), and tetrahydrofuran (200 mL) were added thereto, and the mixture was refluxed overnight at 110° C. The organic solvent was removed using a rotary evaporator, followed by filtration, and the filtrate was acidified to pH<2 with HCl. Then, a resulting precipitate was collected by filtration and washed with distilled water. A product was dried under vacuum at 110° C. to obtain a 2,5-bis(pentoxy)-1,4-benzenedicarboxylic acid (C5BDC) ligand as a beige solid. ¹H NMR (400 MHZ, CDCl₃) δ/ppm 11.11 (s, 2H), 7.88 (s, 2H), 4.30 (t, 4H), 1.91 (m, 4H), 1.44 (m, 8H), 0.95 (t, 6H).

### Synthesis Example 3: 2,5-Bis(octyloxy)-1,4-benzenedicarboxylic Acid (C8BDC) Ligand

Dimethyl 2,5-dihydroxyterephthalate (4.00 g, 17.9 mmol) and K₂CO₃ (7.32 g, 53.0 mmol) were added to dimethylformamide (DMF, 120 mL). Under an Ar atmosphere, 1-bromooctane (9.15 mL, 53.0 mmol) was added thereto and the mixture was stirred at 85° C. for 30 hours. After filtration, the organic solvent was removed from the filtrate using a rotary evaporator. Distilled water (140 mL), KOH (7 g, 125 mmol), and tetrahydrofuran (140 mL) were added thereto, and the mixture was refluxed overnight at 110° C. The organic solvent was removed using a rotary evaporator, followed by filtration, and the filtrate was acidified to pH<2 with HCl. Then, a resulting precipitate was collected by filtration and washed with distilled water. A product was dried under vacuum at 110° C. to obtain a 2,5-bis(octyloxy)-1,4-benzenedicarboxylic acid (C8BDC) ligand as a beige solid. ¹H NMR (400 MHZ, CDCl₃) δ/ppm 10.99 (s, 2H), 7.88 (s, 2H), 4.30 (t, 4H), 1.92 (m, 4H), 1.57-1.44 (m, 4H), 1.42-1.25 (m, 16H), 0.88 (t, 6H).

### Comparative Example 1: IRMOF-1 (or MOF-5) Metal-organic Framework

Zn(NO₃)₂·6H₂O (0.224 g, 0.753 mmol), as a Zn₄O cluster precursor, and terephthalic acid (or 1,4-benzenedicarboxylate, 0.040 g, 0.241 mmol) were dissolved in 10 mL of diethylformamide (DEF) in a vial. The vial was sealed and placed in an oven at 100° C. for 24 hours. After 24 hours, the mother solution was discarded, and a product was washed with fresh diethylformamide (DEF) to obtain cubic crystals of an IRMOF-1 (or MOF-5) metal-organic framework.

### Comparative Example 2: IRMOF-5 Metal-organic Framework

Zn(NO₃)₂·6H₂O (0.224 g, 0.753 mmol), as a Zn₄O cluster precursor, and the C5BDC ligand (0.0675 g, 0.200 mmol) prepared in Synthesis Example 2 were dissolved in 10 mL of diethylformamide (DEF) in a vial. The vial was sealed and placed in an oven at 100° C. for 48 hours. After 48 hours, the mother solution was discarded, and a product was washed with fresh diethylformamide (DEF) to obtain cubic crystals of an IRMOF-5 metal-organic framework.

### Comparative Example 3: IRMOF-8 Metal-organic Framework

Cubic crystals of an IRMOF-8 metal-organic framework were obtained in the same manner in Comparative Example, except that Zn(NO₃)₂·6H₂O (0.075 g, 0.252 mmol), as a Zn₄O cluster precursor, and the C8BDC ligand (0.08 g, 0.189 mmol) prepared in Synthesis Example 3 were used.

### Example 1: CSMOF-C5 Metal-organic Framework (Core/Shell)

The C5BDC ligand (0.134 g, 0.396 mmol) prepared in Synthesis Example 2 was placed in a vial and dissolved in 5 mL of diethylformamide (DEF) containing N,N-diisopropylethylamine (0.046 mL, 0.264 mmol) and N,N-diethyl aniline (0.021 mL, 0.131 mmol). Zn(NO₃)₂·6H₂O (0.379 g, 2.0 mmol), as a Zn₄O cluster precursor, was dissolved in 5 mL of diethylformamide (DEF). The C5BDC ligand solution prepared in Synthesis Example 2 was added to the Zn₄O cluster precursor solution and stirred to prepare a mixture. 25 mg of IRMOF-1 (or MOF-5) metal-organic framework prepared in Synthesis Example 4 was added to the mixture and uniformly distributed in a vial. The vial was sealed and placed in an oven at 100° C. for 48 hours. After 48 hours, the mother solution was discarded, and a product was washed with fresh diethylformamide (DEF) and dichloromethane (DCM) to obtain cubic crystals of a CSMOF-C5 metal-organic framework having a core-shell structure.

### Example 2: MLMOF-C5 Metal-organic Framework (Mixed)

A terephthalic acid solution (0.3 mL, 0.1 M), a C5BDC ligand solution (1.7 mL, 0.1 M) prepared in Synthesis Example 2, and Zn(NO₃)₂·6H₂O (2.0 mL, 0.3 M) as a Zn₄O cluster precursor were added to a 20 mL vial, and 6 mL of diethylformamide (DEF) was additionally added thereto. The vial was sealed and placed in an oven at 100° C. for 48 hours. After 48 hours, the mother solution was discarded, and a product was washed with fresh diethylformamide (DEF) and dichloromethane (DCM) to obtain cubic crystals of a MLMOF-CS metal-organic framework having a mixed-linker structure.

### Example 3: CSMOF-C8 Metal-organic Framework (Core/Shell)

Crystals of a CSMOF-C8 metal-organic framework having a core-shell structure was prepared in the same manner as in Synthesis Example 7, except that the C8BDC ligand (0.134 g, 0.396 mmol) prepared in Synthesis Example 3 was used instead of the C5BDC ligand (0.134 g, 0.396 mmol) prepared in Synthesis Example 2.

### Example 4: MLMOF-C8 Metal-organic Framework (Mixed)

Crystals of a MLMOF-C8 metal-organic framework having a mixed-linker structure was prepared in the same manner as in Synthesis Example 7, except that the C8BDC ligand (0.134 g, 0.396 mmol) prepared in Synthesis Example 3 was used instead of the C5BDC ligand (0.134 g, 0.396 mmol) prepared in Synthesis Example 2.

### Evaluation Example 1: Optical Microscope (OM) Image and Raman Spectroscopy

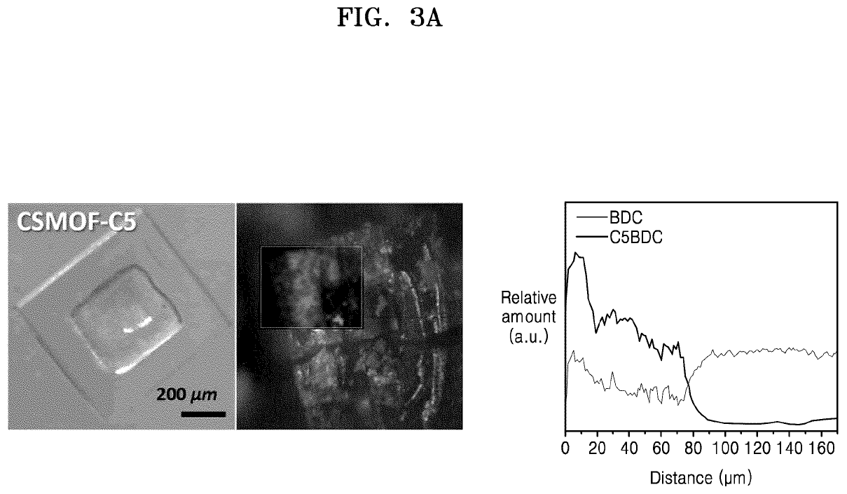

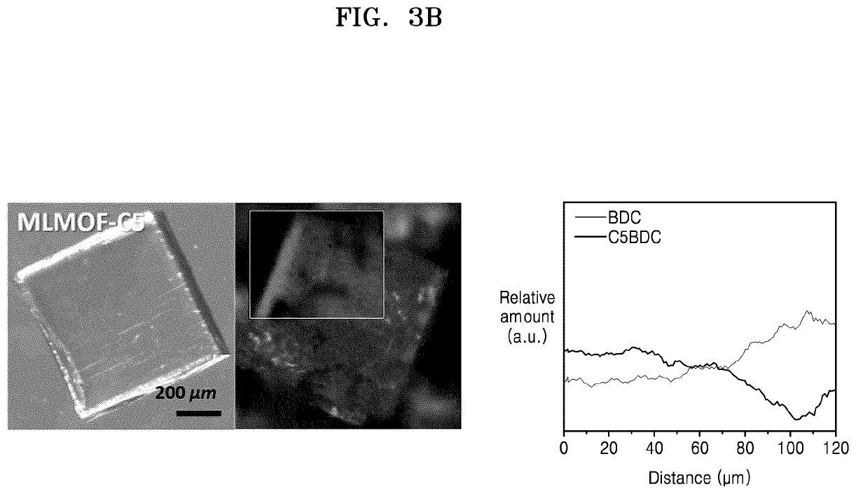

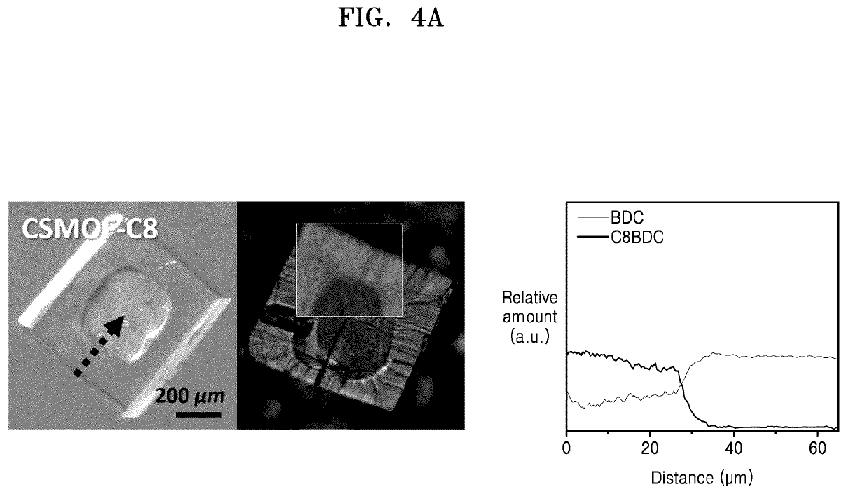

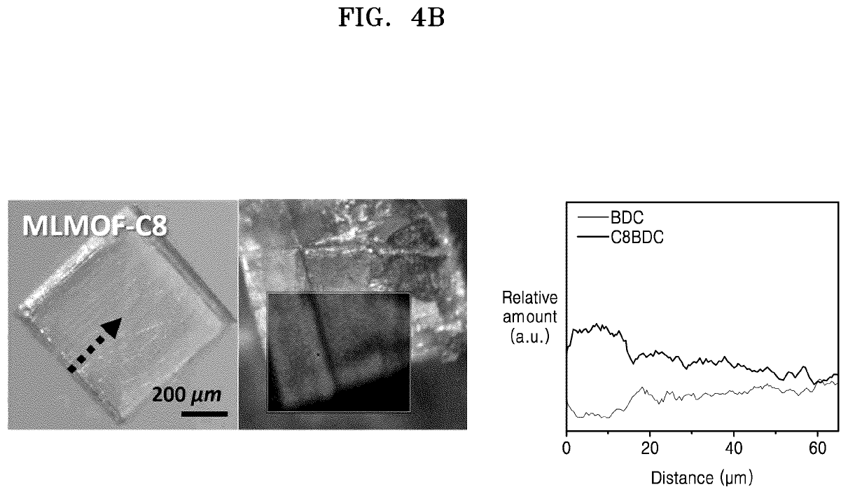

Distribution of ligands in the metal-organic frameworks crystals was analyzed by optical microscope (OM) images and Raman spectroscopy. The results are shown in (a) and (b) of FIG. 3 and (a) and (b) of FIG. 4.

Referring to (a) of FIG. 3 and (a) of FIG. 4, both the CSMOF-C5 metal-organic framework and the CSMOF-C8 metal-organic framework prepared in Examples 1 and 3, respectively, exhibited images in which two different types of ligands were distinctly separated and distributed into the core and the shell. In addition, the CSMOF-C5 metal-organic framework and the CSMOF-C8 metal-organic framework exhibited that the C5BDC ligand or the C8BDC ligand were predominant at the vertices (or surfaces) of the crystal, and terephthalic acid (or 1,4-benzenedicarboxylate) is predominant at the central position of the crystal.

Referring to (b) of FIG. 3 and (b) of FIG. 4, both the MLMOF-C5 metal-organic framework and the MLMOF-C8 metal-organic framework prepared in Examples 2 and 4, respectively, exhibited images in which two different types of ligands were randomly distributed. In addition, the MLMOF-C5 metal-organic framework and the MLMOF-C8 metal-organic framework exhibited a tendency in which a proportion of the C5BDC ligand or the C8BDC ligand gradually increased from the center of the crystal toward the surface.

### Evaluation Example 2: Gas Adsorption Experiment-Adsorption Amount, Working Capacity, and Productivity

(1) Isothermal Adsorption Experiment of Ethane (C₂H₆) and Ethylene (C₂H₄) Gas

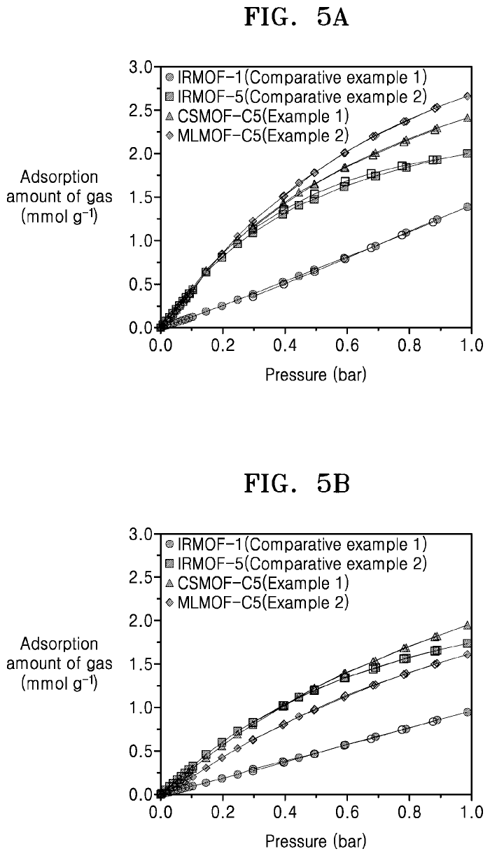

Isothermal adsorption experiments of ethane (C₂H₆) and ethylene (C₂H₄) gases were carried out using a TriStar II gas adsorption analyzer (Micromeritics Instruments Co.) while maintaining a constant temperature with an isothermal bath. Measurements for each sample gas were performed up to 1 bar at two temperatures, 273 K and 298 K. All samples, i.e., the IRMOF-1, IRMOF-5, CSMOF-C5, and MLMOF-C5 metal-organic frameworks prepared in Comparative Examples 1 and 2 and Examples 1 and 2, respectively, were degassed under vacuum at 403 K for 12 hours. Using the TriStar II analyzer, periodic C₂H₆ and C₂H₄ adsorption isotherms at 298 K were obtained for 10 cycles, with mild vacuum regeneration for 5 minutes between each cycle. The results are shown in (a) and (b) of FIG. 5.

Referring to (a) and (b) of FIG. 5, the IRMOF-1, IRMOF-5, CSMOF-C5, and MLMOF-C5 metal-organic frameworks prepared in Comparative Examples 1 and 2 and Examples 1 and 2, respectively, exhibited higher adsorption amounts of ethane (C₂H₆) gas than those of ethylene (C₂H₄) gas. Among them, the MLMOF-C5 metal-organic framework prepared in Example 2 exhibited a far higher adsorption amount of ethane (C₂H₆) gas than that of ethylene (C₂H₄) gas.

In addition, C₂H₆ working capacities of the CSMOF-C5 and MLMOF-C5 metal-organic frameworks prepared in Examples 1 and 2, respectively, were determined by substituting isotherm data of C₂H₆ gas adsorption measured at 298K shown in (a) of FIG. 5 into Equation 1 below.

$${C}_{2} {H}_{6} working capacity ( mmol {g}^{- 1} ) = [ ( adsorption amount of {C}_{2} {H}_{6} @ 1 bar ) - ( adsorption amount of {C}_{2} {H}_{6} @ 0.1 bar ) ] \qquad [ Equation 1 ]$$

The C₂H₆ working capacities of the CSMOF-C5 and MLMOF-C5 metal-organic frameworks prepared in Examples 1 and 2 which were calculated using Equation 1 were 1.95 mmol g⁻¹ and 2.24 mmol g⁻¹, respectively. That is, the C₂He working capacities of the CSMOF-C5 and MLMOF-C5 metal-organic frameworks prepared in Examples 1 and 2 were higher than the C₂H₆ working capacity (1.42 mmol g⁻¹) of Fe₂O₂ (dobdc), which is previously known in the art and disclosed in L. Li, R. B. Lin, R. Krishna, H. Li, S. Xiang, H. Wu, J. Li, W. Zhou, B. Chen, Science 2018, 362, 443-446.

In addition, productivity of high-purity ethylene (C₂H₄) (>99.9 or more) was obtained under dry conditions by substituting isotherm data of C₂H₆ gas adsorption measured at 298K shown in (b) of FIG. 5 into Equation 2 below.

$$Productivity = \frac{{\int }_{{t}_{2}}^{{t}_{1}} q C ( t ) dt}{m} \qquad [ Equation 2 ]$$

In Equation 2,
t₁ and t₂ are time at which a C₂H₄ concentration is 99.9% or more,
q is a feed flow (ml/min),
C(t) is a concentration of eluted C₂H₄, and
m is a weight (g) of the packed adsorbent.

Productivity of high-purity ethylene (C₂H₄) (>99.9 or more) of the MLMOF-C5 metal-organic framework prepared in Example 2, obtained, under dry conditions, by using Equation 2 was 19.7 L/kg, which was considerably high.

### (2) Isothermal Adsorption Experiment of Xenon (Xe) and Krypton (Kr) Gas

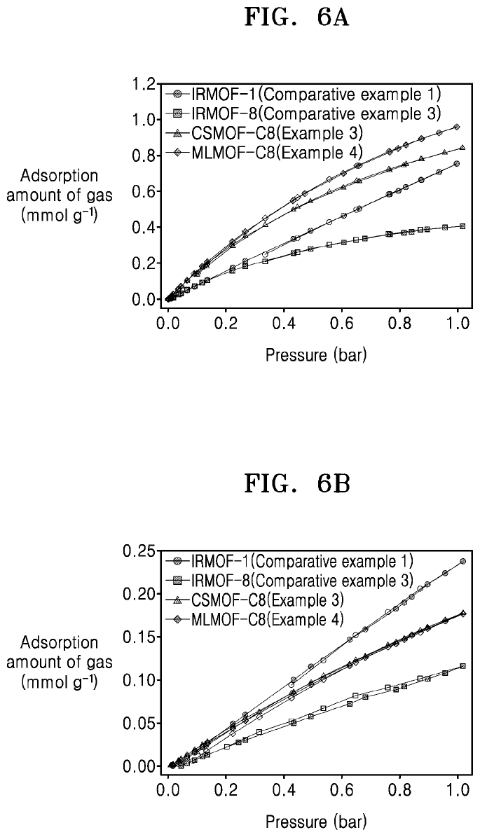

Isothermal adsorption experiments of xenon (Xe) and krypton (Kr) gases were carried out in the same manner as the isothermal adsorption experiments of ethane (C₂H₆) and ethylene (C₂H₄), except that for each gas, the IRMOF-1, IRMOF-8, CSMOF-C8, and MLMOF-C8 metal-organic frameworks prepared in Comparative Examples 1 and 3 and Examples 3 and 4 were degasses up to 100 kPa under vacuum at 403 K for 1 hour (<1.0×10⁻⁵ mmHg) at two temperatures (273 K and 298 K) before measurement. By mild vacuum regeneration for 20 minutes between cycles, periodic xenon (Xe) and krypton (Kr) gas adsorption isotherms were obtained at 298 K for five cycles. The results are shown in (a) and (b) of FIG. 6.

Referring to (a) and (b) of FIG. 6, similar to the isothermal adsorption experiments of ethane (C₂H₆) and ethylene (C₂H₄), all of the IRMOF-1, IRMOF-8, CSMOF-C8, and MLMOF-C8 metal-organic frameworks prepared in Comparative Examples 1 and 3 and Examples 3 and 4, respectively, exhibited higher adsorption amounts of xenon (Xe) gas than those of krypton (Kr) gas. Among them, the MLMOF-C8 metal-organic framework prepared in Example 4 exhibited a far higher adsorption amount of xenon (Xe) gas than that of krypton (Kr) gas.

In addition, under dry conditions, productivity of high-purity krypton (Kr) (>99.9 or more) of the MLMOF-C8 metal-organic framework prepared in Example 4 was obtained by substituting isotherm data of Kr gas adsorption at 298 K shown in (b) of FIG. 6 into Equation 3 below.

$$Productivity = \frac{{\int }_{{t}_{2}}^{{t}_{1}} q C ( t ) dt}{m} \qquad [ Equation 3 ]$$

In Equation 3,
t₁ and t₂ are time at which a Kr concentration is 99.9% or more,
q is a feed flow (ml/min),
C(t) is a concentration of eluted Kr, and
m is a weight (g) of the packed adsorbent.

Productivity of high-purity krypton (Kr) (>99.9 or more) of the MLMOF-C8 metal-organic framework prepared in Example 4, obtained by using Equation 3 under dry conditions was 11.3 L/kg, which was considerably high.

### Evaluation Example 3: Ideal Adsorbed Solution Theory (IAST) Selectivity

Selectivity for ethane (C₂H₆) and ethylene (C₂H₄) gases and selectivity for xenon (Xe) and krypton (Kr) gases was evaluated by prediction using the ideal adsorbed solution theory (IAST).

Evaluation on the IAST selectivity for ethane (C₂H₆) and ethylene (C₂H₄) gases was performing using the IRMOF-1, IRMOF-5, CSMOF-C5, and MLMOF-C5 metal-organic frameworks prepared in Comparative Examples 1 and 2 and Examples 1 and 2, and evaluation on the IAST selectivity for xenon (Xe) and krypton (Kr) gases was performing using the IRMOF-1, IRMOF-8, CSMOF-C8, and MLMOF-C8 metal-organic frameworks prepared in Comparative Examples 1 and 3 and Examples 3 and 4.

The ideal adsorbed solution theory (IAST), developed by Myers and Prausnitz, refers to a theoretical method that predicts multicomponent adsorption isotherms by using single-component adsorption isotherm data. For application to the IAST calculations, the single-component adsorption isotherms were fitted to the dual-site Langmuir-Freundlich, (DSLF) model to obtain the corresponding parameters (R²>0.9999).

The dual-site Langmuir-Freundlich, (DSLF) model is defined by Expression 1 below.

$${q}_{i} = {q}_{1} \frac{{( {k}_{1} * p )}^{{n}_{1}}}{1 + {( {k}_{1} * p )}^{{n}_{1}}} + {q}_{2} \frac{{( {k}_{2} * p )}^{{n}_{2}}}{1 + {( {k}_{2} * p )}^{{n}_{2}}} \qquad ( 1 )$$

The IAST selectivity, defined by Expression 2 below, was predicted by using the parameters obtained by the DSLF fitting

$${S}_{AB} = \frac{{x}_{A} / {y}_{B}}{{x}_{B} / {y}_{B}} \qquad ( 2 )$$

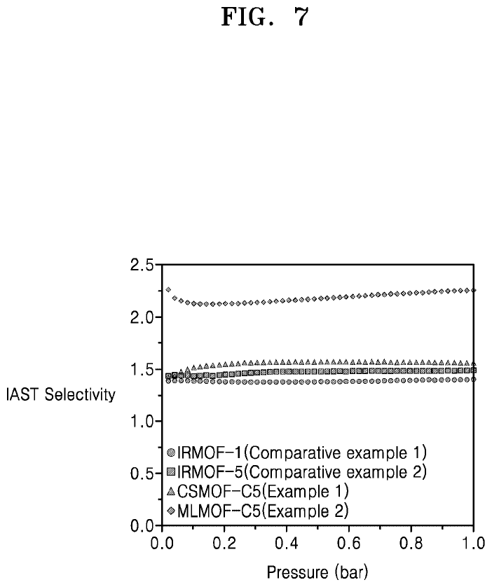

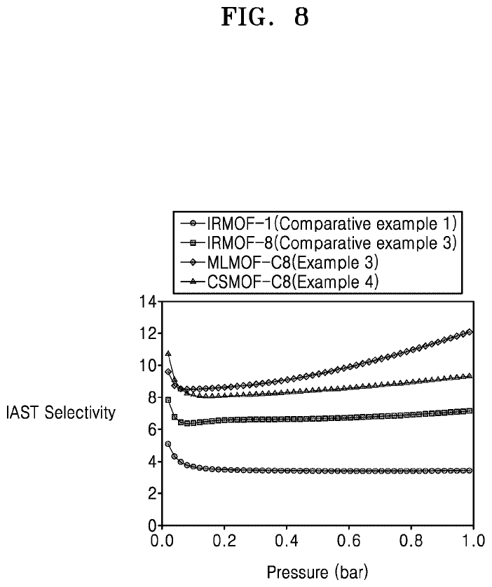

In Expression (2), xᵢ represents adsorption amounts of gases A and B, and yᵢ represents mole fractions of gases A and B in the bulk phase. The IAST gas selectivity for ethane (C₂H₆) and ethylene (C₂H₄) was predicted under the mixture of two gases of ethane (C₂H₆) and ethylene (C₂H₄) (50/50 and 1/15, v/v, respectively). The IAST gas selectivity for xenon (Xe) and krypton (Kr) was predicted under the mixture of two gases of xenon (Xe) and krypton (Kr) (50/50 and 20/80, v/v, respectively). The results are shown in FIGS. 7 and 8, respectively.

Referring to FIG. 7, among the IRMOF-1, IRMOF-5, CSMOF-C5, and MLMOF-C5 metal-organic frameworks prepared in Comparative Examples 1 and 2 and Examples 1 and 2, the MLMOF-C5 metal-organic framework prepared in Example 2 exhibited the highest selectivity of 2.25 for the mixed gas of ethane (C₂H₆) and ethylene (C₂H₄).

Referring to FIG. 8, among the IRMOF-1, IRMOF-8, CSMOF-C8, and MLMOF-C8 metal-organic frameworks prepared in Comparative Examples 1 and 3 and Examples 3 and 4, the MLMOF-C8 metal-organic framework prepared in Example 4 exhibited a considerably high selectivity of 12.1 for the mixed gas of xenon (Xe) and krypton (Kr).

### Evaluation Example 4: Dynamic Breakthrough Experiment-Separation Performance

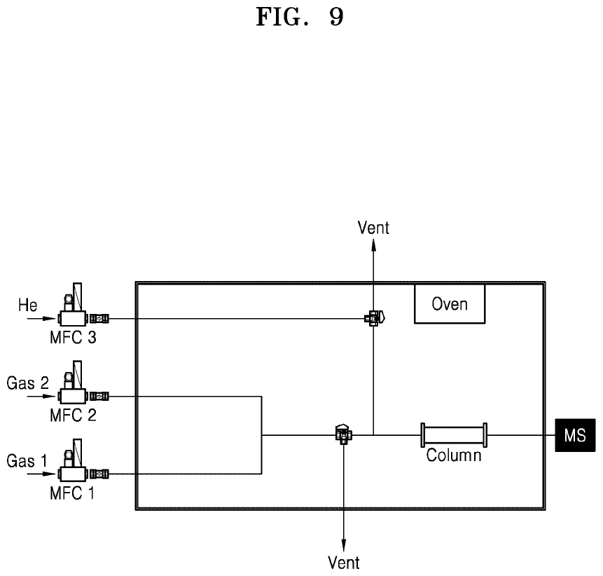

A dynamic breakthrough experiment was performed using a customized fixed-bed setup as shown in FIG. 9. Three mass flow controllers (MFCs) (0 to 100 mL/min) (Bronkhorst, Germany) were used to regulate the gas flow to the fixed bed. Two of the MFCs were connected to the pure C₂H₆ and C₂H₄ gas lines, respectively, and the two gas lines were connected by flowing the gases through a gas mixer to prepare the C₂H₆/C₂H₄ mixed gas, whereas a third MFC was connected to a helium gas line to regenerate the adsorbent packed inside the column. The column was placed in a well-ventilated temperature-controlled oven to maintain a constant temperature of 298 K, and pressure regulators were attached to the inlet and outlet of the column to monitor a pressure drop in the column. The outlet gas composition of the column was measured using a MAX300-LG mass spectrometer (Extrel, USA). The metal-organic framework sample powder was pelletized into binder-free pellets (500 to 1000 μm) to prevent excessive pressure drop. After degassing the pellets under vacuum at 403 K, they were loaded into a stainless-steel column (150 mm×4.4 mm). The void space inside the column was filled with glass beads (750 μm) and glass wool. After packing the adsorbent into the column, the column was further degassed with helium at 50 mL/min at 403 K for at least 1 hour to remove impurities adsorbed during the packing step. Thereafter, prior to initiating the experiment, the helium gas flow was reset to 7 mL/min for a 1:1 (v/v) mixed gas and to 24 mL/min for a 1:15 (v/v) mixed gas. At t=0, the helium flow was switched to the binary C₂H₆/C₂H₄ mixed gas flow. A total flow rate was 7 mL/min for the 1:1 (v/v) mixture and 24 mL/min for the 1:15 (v/v) mixture.

(1) Separation Performance of Ethane (C₂H₆)/Ethylene (C₂H₄)

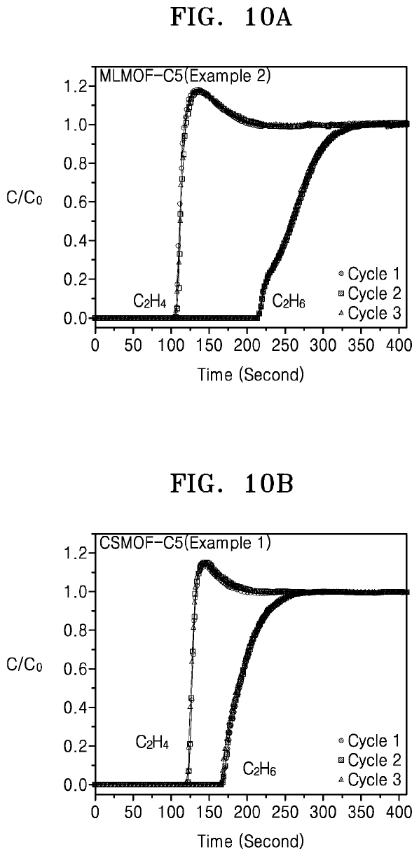

Ethylene (C₂H₄) separation performance from a mixed gas of ethane (C₂H₆) and ethylene (C₂H₄) (50/50, v/v) was evaluated on the CSMOF-C5 and MLMOF-C5 metal-organic frameworks prepared in Examples 1 and 2. The results are shown in (a) and (b) of FIG. 10.

Referring to (a) and (b) of FIG. 10, both the CSMOF-C5 metal-organic framework (b) and the MLMOF-C5 metal-organic framework (a) exhibited stable separation performance, maintaining identical performance over three ethane (C₂H₆)/ethylene (C₂H₄) separation cycles. Among them, the MLMOF-C5 metal-organic framework exhibited more efficient ethane (C₂H₆)/ethylene (C₂H₄) separation performance than the CSMOF-C5 metal-organic framework due to a longer retention time.

### (2) Separation Performance of Xenon (Xe)/Krypton (Kr)e

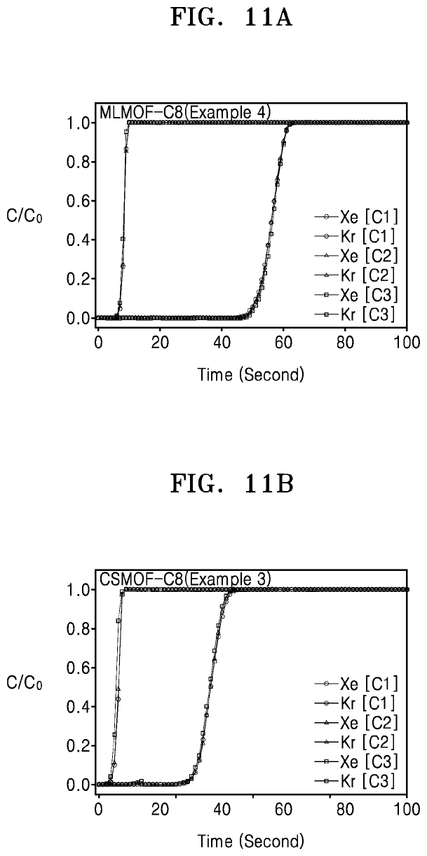

Krypton (Kr) separation performance from a mixed gas of xenon (Xe) and krypton (Kr) (50/50, v/v) was evaluated on the CSMOF-C8 and MLMOF-C8 metal-organic frameworks prepared in Examples 3 and 4. The results are shown in (a) and (b) of FIG. 11.

Referring to (a) and (b) of FIG. 11, both the CSMOF-C8 metal-organic framework (b) and the MLMOF-C8 metal-organic framework (a) exhibited stable separation performance, maintaining identical performance over three xenon (Xe)/krypton (Kr) separation cycles. Among them, the MLMOF-C8 metal-organic framework exhibited more efficient xenon (Xe)/krypton (Kr) separation performance than the CSMOF-C8 metal-organic framework due to a longer retention time.

1. A metal-organic framework with a three-dimensional porous network structure, comprising:
a Zn₄O cluster; and
two or more types of carboxyl group-based aromatic ligands having different degrees of bulkiness,
wherein one of the carboxyl group-based aromatic ligands comprises a carboxyl group-based aromatic ligand including a C4-C8 alkoxy group,
an opening is defined by the carboxyl group-based aromatic ligands, and
the opening has a multivariated size due to vibration of a pendant chain of the C4-C8 alkoxy group.

2. The metal-organic framework of claim 1, wherein the carboxyl group-based aromatic ligand comprises an unsubstituted carboxyl group-based aromatic ligand and a carboxyl group-based aromatic ligand including a C4-C8 alkoxy group.

3. The metal-organic framework of claim 1, wherein
the carboxyl group-based aromatic ligand comprises 1,4-benzenedicarboxylate and 2,5-bis(alkoxy)benzenecarboxylate represented by Formula 2 below: 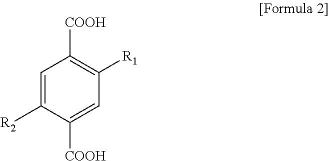
wherein in Formula 2,
R₁ and R₂ are each independently an unsubstituted C4-C8 alkoxy group.

4. The metal-organic framework of claim 1, wherein a major axis diameter of the opening is 1.5 Å to 4.2 Å.

5. The metal-organic framework of claim 1, wherein the pendant chain of the C4-C8 alkoxy group of the carboxyl group-based aromatic ligand including a C4-C8 alkoxy group is densely distributed in the opening.

6. The metal-organic framework of claim 5, wherein an opening smaller than the opening is additionally defined in the opening by the pendant chain of the C4-C8 alkoxy group.

7. The metal-organic framework of claim 6, wherein the pendant chain of the C4-C8 alkoxy group narrows a distance between a target molecule and the Zn₄O cluster in the smaller opening to enhance interactions therebetween.

8. The metal-organic framework of claim 1, wherein
the metal-organic framework has a core-shell structure, and
a ligand located in the shell is bulkier than a ligand located in the core.

9. The metal-organic framework of claim 8, wherein an opening of the shell is a space for capturing the target molecule, and an opening of the core is a space for storing the target molecule.

10. The metal-organic framework of claim 9, wherein the target molecule is ethane (C₂H₆) or xenon (Xe).

11. The metal-organic framework of claim 1, wherein a proportion of the bulkier ligand among the two or more types of carboxyl group-based aromatic ligands increases from a center of the metal-organic framework to the surface of the metal-organic framework, according to a crystallization rate.

12. The metal-organic framework of claim 11, wherein a proportion of the bulkier ligand present on the surface is 80 wt % or more based on a total weight of the metal-organic framework.

13. The metal-organic framework of claim 1, wherein a total volume of the opening is 0.50 cm³/g or more based on a total volume of the metal-organic framework.

14. The metal-organic framework of claim 1, wherein the metal-organic framework selectively separates ethylene (C₂H₄) gas from a mixed gas of ethylene (C₂H₄) and ethane (C₂H₆).

15. The metal-organic framework of claim 1, wherein the metal-organic framework selectively separates krypton (Kr) gas from a mixed gas of xenon (Xe) and krypton (Kr).

16. An adsorbent comprising the metal-organic framework of claim 1.

17. A method of preparing a metal-organic framework with a three-dimensional porous network structure, the method comprising:
preparing a solution including a first carboxyl group-based aromatic ligand; and
adding a Zn₄O cluster precursor solution, and a first metal-organic framework including a Zn₄O cluster and a second carboxyl group-based aromatic ligand to the solution including the first carboxyl group-based aromatic ligand, followed by heat-setting at a temperature of 70° C. to 95° C. and then leaving to stand to obtain a second metal-organic framework crystal having a core-shell structure,
wherein the first carboxyl group-based aromatic ligand is a carboxyl group-based aromatic ligand including a C4-C8 alkoxy group,
the second carboxyl group-based aromatic ligand is less bulky than the first carboxyl group-based aromatic ligand,
an opening is defined by the first carboxyl group-based aromatic ligand and the second carboxyl group-based aromatic ligand, and
in the second metal-organic framework crystal,
the first carboxyl group-based aromatic ligand is located in the shell, and
the second carboxyl group-based aromatic ligand is located in the core.

18. (canceled)

19. The method of claim 17, wherein the opening has a multivariated size due to vibration of a pendant chain of the C4-C8 alkoxy group.

20. (canceled)

21. (canceled)

22. (canceled)

23. (canceled)

24. The method of claim 17, wherein the metal-organic framework selectively separates ethylene (C₂H₄) gas from a mixed gas of ethylene (C₂H₄) and ethane (C₂H₆).

25. The method of claim 17, wherein the metal-organic framework selectively separates krypton (Kr) gas from a mixed gas of xenon (Xe) and krypton (Kr).
